(19) United States
(12) Patent Application Publication
(10) Pub. No.: US 2026/0299890 A1
(43) Pub. Date: Oct. 1, 2026

(54) Generative Model Performance Measure

(71) Applicants: David J. Marchette, King George, VA (US); Rakesh M. Verma, Houston, TX (US)

(72) Inventors: David J. Marchette, King George, VA (US); Rakesh M. Verma, Houston, TX (US)

(73) Assignee: United States of America, as represented by the secretary of the Navy, Arlington, VA (US)

(21) Appl. No.: 19/443,220

(22) Filed: Jan. 8, 2026

Related U.S. Application Data
(60) Provisional application No. 63/778,573, filed on Mar. 27, 2025.

(51) Int. Cl. G06F 8/30; G06F 8/73

(52) U.S. Cl. CPC G06F 8/30; G06F 8/73

(57) ABSTRACT

A computer implemented method is provided for evaluating software documentation of a source code to generate an alternate code. The method includes receiving the source code; parsing and interpreting the source code; producing a text document that describes purpose and functionality based on the source code; comparing the text document to the source code for completeness; and creating the alternate code from the functionality of the text document. Additionally, the method can further include measuring parameters such as comment density, clarity and consistency, traceability, readability, cohesion and structure, functional accuracy, grammatical quality and continued maintainability.

### CROSS REFERENCE TO RELATED APPLICATION

Pursuant to 35 U.S.C. § 119, the benefit of priority from provisional application 63/778,573, with filing date of Mar. 27, 2025, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to computer code documentation and translation. In particular, the invention relates to modeling computer language instructions into human-readable documentation to assess accuracy to replicate such instructions in another computer language.

Computer source code has expanded over the past several decades. Such code is compiled and executed on digital machine platforms to perform a specific task involving numerical computation and logical operations. Maintenance of such code includes documentation, necessary for users to execute and developers to modify and augment. Software documentation has historically been inconsistent in quality, such as in terms of readability, accuracy and completeness.

User manuals are written to enable software to be executed for its intended purpose. Code management reports can provide insight into the structure of machine instructions, as well as aid in efforts of modification as needed. As developers transition legacy code executed in established operating systems into more modern analogs, examination of documentation in a systemic fashion becomes necessary. Otherwise, capability gaps can disable the utility of pre-existing code instructions.

### SUMMARY

Conventional code documentation techniques yield disadvantages addressed by various exemplary embodiments of the present invention. In particular, various exemplary embodiments provide a computer implemented method for evaluating software documentation of a source code to generate an alternate code. The method includes receiving the source code; parsing and interpreting the source code; producing a text document that describes purpose and functionality based on the source code; comparing the text document to the source code for completeness; and creating the alternate code from the functionality of the text document. Additionally, the method can further include measuring parameters such as comment density, clarity and consistency, traceability, readability, cohesion and structure, functional accuracy, grammatical quality and continued maintainability.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIGS. 1A, 1B, 1C and 1D are tabular views of characteristic parameters for software documents;

FIG. 2 is a flowchart view of a document analysis and comparison;

FIGS. 3A and 3B are window box views of prompts;

FIG. 4 is a window box view of a code instruction with comment;

FIG. 5 is a flowchart view of an iterative code generation process;

FIG. 6 is a window box view of a documentation file; and

FIGS. 7A, 7B, 7C, 7D, 7E, 7F and 7G are text views of code and documentation.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, those of ordinary skill in the art will readily recognize that devices of a less general purpose nature, such as hardwired devices, or the like, may also be used without departing from the scope and spirit of the inventive concepts disclosed herewith. General purpose machines include devices that execute instruction code. A hardwired device may constitute an application specific integrated circuit (ASIC), a field programmable gate array (FPGA), a digital signal processor (DSP) or other related component.

The objective of this disclosure is to describe the process of analyzing software documentation to facilitate code translation. Exemplary embodiments cover the concept of quality assessment and comparison. One potential example of this technology involves taxonomy for quantifying characteristics of available documents that describe a code of interest. Technical background includes Cybersecurity Analysis by R. M. Verma and D. J. Marchette, CRC Press, (2020) §§ 6.8 through 8.6.3.

Analysis and Literature: The software engineering field has been evolving since the 1970s. A search for the phrase “software documentation” in article titles produces more than a thousand matches. This disclosure provides a comprehensive taxonomy for measuring software documentation quality, and the associated literature has been surveyed.

A high-level program or code in a programming language L is a well-formed string over the alphabet of L, which follows the rules of L, which is executable on a computer. Documentation in a documentation language DL is a well-formed string over alphabet of DL, which describes the goals, properties, and assumptions of a program or code. Software documentation is considered an important task for software system developers and is one of the most critical pieces of information for software users and maintainers apart from the code itself.

There is a well-known maxim: If something cannot be quantifiably measured, one cannot improve it. Because documentation is such a critical piece of information for a diverse audience, it should be of high quality, viz., it should provide useful, reliable, up-to-date, and accurate information about the software system. Software engineering researchers have developed a plethora of formats for writing software documents, and also proposed many guidelines, and tools for evaluating its quality. However, so far, there has been no consensus as to the right set of metrics to use to measure the quality of software documentation.

Because of the lack of consensus, a comprehensive catalog of techniques and principles can be desirable for evaluating software documentation. One can call these techniques software documentation metrics (documentation metrics for short). In this disclosure, three different kinds of documentation metrics are covered:
1. metrics that evaluate the quality of software documentation in a standalone fashion, or that compare software documents for the same program;
2. metrics that measure the complexity of a program, or that compare two different programs for the same task; and
3. metrics that compare software documentation(s) to the program presumed to be documenting.

The primary contributions of exemplary embodiments include:
Based on this review of the literature on software documentation quality, first a taxonomy of documentation metrics is hereby proposed.
Next, the principles for evaluating the metrics themselves are covered.
Then, guided by this taxonomy, the popular and/or principled metrics for assessing software documentation quality can be discussed.

For the purposes of this disclosure, one calls a metric standalone if no ground truth is required for evaluation, and comparative otherwise. The disclosure provides a brief discussion of the literature, standalone metrics with tools for measuring these metrics, as well as comparison metrics for comparing code to documentation along with those designed for comparing automatically generated documentation to developer written documentation and metrics for object-oriented design. Further included are criteria for evaluating metrics, similarity metrics from the AMR paper by Yuan Huang et al.: “Are your comments outdated? toward automatically detecting code-comment consistency”, Journal of Software: Evolution and Process, 37(1): e2718 (2025) present applications of text-to-text comparisons, and various pitfalls in using metrics.

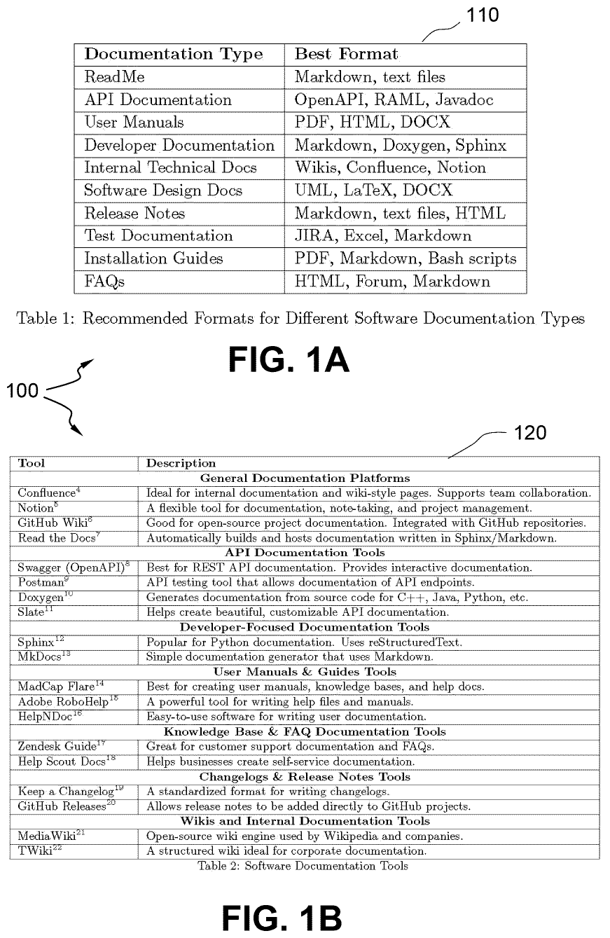

Related literature is presented into documentation formats, metrics for documentation quality, tools for documentation, and previous surveys/reviews of software documentation quality metrics. FIGS. 1A, 1B, 1C and 1D provide tabular views 200 related to software documentation. These include Table 1 as Formats 110 in FIG. 1A, Table 2 as Tools 120 in FIG. 1B, Table 3 as Semantic Metrics 130 in FIG. 1C and Table 4 as a comparative values set 140 in FIG. 1D.

In particular, FIG. 1A for Table 1 lists a left column of documentation type associated with a right column of preferable formats optimized for the respective document. For example, user's manuals are typically presented as electronic .pdf, .html or .docx, depending on the medium. FIG. 1B for Table 2 presents a left column of tools grouped by application accompanied by a right column of descriptions for these respective tools. For example, among General Documentation Platforms, GitHub Wiki is described as appropriate for open-source projects. Similarly for Developers, Sphinx can be employed for the Python language.

FIG. 1C for Table 3 provides a comparison of semantic metrics as described subsequently. The left-most column lists the associated program for metrics evaluation, while the other columns identify whether these tools include capture semantics, paraphrasing and cost computation, as well as optimized purpose. FIG. 1D for Table 4 lists programs on the left-most column, with other columns indicating a numerical value for Levenshtein Similarity (LS), Jaccard Similarity (JS), Cosine Similarity (CS) and Jaccard Similarity for Bags (JSB) comparison. These metrics are described subsequently.

Formats—Contrary to Parnas' proposal for mathematical precision in software documentation by Jacob Katzenelson: “Documentation and the management of a software project—a case study”, Software: Practice and Experience 1(2): 147-157 (1971), such documents are essentially always written in a natural language such as English or Mandarin. However, several formats have been proposed for making it easier to access software documentation online.

Metrics—Because one can use natural languages as the basis for software documentation, all metrics that can assess the quality of text are potentially relevant for measuring software documentation quality. For text comparison metrics, Ananya B. Sai et al.: “A survey of evaluation metrics used for NLG systems”, ACM Computing Surveys (CSUR) 55(2): 1-39 (2022, preprint available at https://arxiv.org/pdf/2008.12009) can be consulted for an excellent taxonomy and survey for natural language generation systems.

But text quality assessment is an old topic. Teachers have been marking student essays for a long time based on originality of thought and quality of expression which takes into account factors such as readability, non-redundancy, coherence, and clarity. Clarity includes ambiguity, consistency and precision. In this context, the proposals by Mohsen Mesgar and Michael Strube: “A neural local coherence model for text quality assessment”, Proceedings of the 2018 Conference on Empirical Methods in Natural Language Processing, 4328-4339, Brussels, Belgium (October-November 2018, at https://aclanthology.org/D18-1464.pdf) by the Association for Computational Linguistics, and Avisha Das and Rakesh M. Verma. “Can Machines Tell Stories? a comparative study of deep neural language models and metrics”, IEEE Access 8:181258-181292 (2020, available at https://scispace.com/pdf/can-machines-tell-stories-a-comparative-study-of-deepneural-1p69xukroj.pdf) for measuring local coherence are interesting and relevant.

Similarly, readability metrics such as Gunning-Fog index from Shixiang Zhou et al.: “How consistent are the best-known readability equations in estimating the readability of design standards?”, IEEE Transactions on Professional Communication 60(1): 97-111 (2017, available at https://ieeexplore.ieee.org/stamp/stamp.jsp?tp=&arnumber=7839917) and Flesch-Kincaid score from Derar Eleyan et al.: “Enhancing software comments readability using flesch reading ease score”, Information, 11(9), 430 (2020, available at https://mdpi-res.com/d_attachment/information/information-11-00430/article_deploy/information-11-00430-with-cover.pdf?version=1686790566) are also relevant. See also Scott A. Crossley et al.: “Moving Beyond Classic Readability Formulas: New methods and new models”, Journal of Research in Reading, 42(3-4), 541-561 (2019, at https://www.researchgate.net/profile/MihaiDascalu-2/publication/335801547_Moving_beyond_classic_readability_formulas_new_methods_and_new_models/links/5e4cfbe7299bflcdb935864d/Moving-beyond-classicreadability-formulas-new-methods-and-new-models.pdf), and Matej Martinc et al.: “Supervised and Unsupervised Neural Approaches to Text Readability”, Computational Linguistics, 47(1): 141-179 (2021, available at https://direct.mit.edu/coli/article-pdf/47/1/141/1911429/coli_a_00398.pdf). Researchers have identified several metrics for assessing the quality of software documentation and comments.

Several sources provide commonly used metrics. These include, e.g., Daniela Steidl et al.: “Quality Analysis of Source Code Comments,” 21^{st} International Conference on Program Comprehension (ICPC), 83-92, (2013, at https://www.teamscale.com/hubfs/26978363/Publications/2013-quality-analysis-of-source-code-comments.pdf); Junji Zhi et al.: “Cost, Benefits and Quality of Software Development Documentation: A Systematic Mapping”, Journal of Systems and Software 99:175-198 (2015, at https://sci-hub.st/10.1016/j.jss.2014.09.042 and https://pureadmin.qub.ac.uk/ws/portalfiles/portal/180321024/SM_Documentation_revison_Sept_26.pdf); and Christoph Treude et al.: “Beyond Accuracy: assessing software documentation quality”, Proceedings of the 28^{th} ACM Joint Meeting on European Software Engineering Conference and Symposium on the Foundations of Software Engineering, (ESEC/FSE), 1509-1512 (2020, available at https://ctreude.ca/wp-content/uploads/2020/10/fse20d.pdf)—Association of Computing Machinery.

The popular metrics from the above sources are presented below:
1. Comment Density: Measures the ratio of comments to code lines, indicating the volume of documentation relative to code. Because lines have different lengths, a better measure would be the characters devoted to documentation (normalizing redundant spaces and characters) versus the characters devoted to code (again removing any redundant characters and spaces). Even better would be to count tokens, as defined by the language.
2. Completeness: Assesses whether all necessary parts of a document are present, especially requirements, design, and testing components.
3. Clarity and Consistency: Are there any ambiguities in the documentation, and is it free from contradictions?
4. Readability and Understandability: Uses readability scores (e.g., Flesch-Kincaid) to evaluate the ease of comprehension.
5. Update Frequency: Tracks how often documentation is revised, showing responsiveness to code changes.
6. Traceability: Assesses the ability of the documentation to link code changes with requirements or design documents.
7. Cohesion and Structure: Measures how well the documentation sections are organized and connected, enhancing navigability.
8. Relevance and Accuracy: Checks if comments and documentation accurately reflect the code's intent and functionality.
9. Maintainability: Measures the ease with which documentation can be updated, often linked to modularity and clarity.
10. Effectiveness: Does the documentation make effective use of technical vocabulary?
11. Quality: How well written is the document (e.g., spelling and grammar)?
12. Appeal: How interesting is it?
13. Accessibility: How easy it is to find the documentation?

Because programmers find useful documentation to be challenging to create and maintain, there have been several works on automatic generation of documentation over the past decade or so. To evaluate this generated documentation, three types of approaches have been proposed:
(a) using metrics borrowed from the language translation, e.g., BLEU, codeBLEU, c_coeff, ChrF, Jaccard, METEOR, ROUGE, which require a reference (summary, document, or code) to compare with;
(b) embeddings based metrics such as BERTscore, CodeT5+_CS, InferSent, SentenceBERT, TF-IDF, UniversalSentenceEncoder, word mover's distance, which also require a reference for comparison; and
(c) human evaluation using the criteria listed above.

In 2024, a metric called SIDE (Summary alignment to coDe SEmantics) was proposed by Antonio Mastropaolo et al.: “Evaluating Code Summarization Techniques: A new metric and an Empirical Characterization”, Proceedings of the IEEEIACM 46^{th} International Conference on Software Engineering, 1-13 (2024, at https://dl.acm.org/doi/pdf/10.1145/3597503.3639174) and compared against thirty-nine variants of previous metrics: Rouge (eighteen variants), BERTscore (Precision, Recall and Fscore) BLEU (five variants), UniversalSentenceEncoder (five variants), SentenceBERT (five variants), InferSent (five variants), METEOR, Jaccard, TF-IDF (five variants), ChrF, c_coeff, and CodeT5+_CS. This metric leverages contrastive learning and has the highest Spearman ρ among those metrics tested.

There are also distributional metrics, which provide an overview of a set of documents against a reference set of documents, e.g., Mauve, MS-Jaccard, Frechet BERT distance and Bhattacharyya distance from Ehsan Montahaei et al.: “Jointly measuring diversity and quality in text generation models”, CoRR, abs/1904.03971 (2019, at https://aclanthology.org/W19-2311.pdf).

A 2023 survey found only one automated assessment tool, AppGrader between 2017 and 2021 that discussed assessing documentation by John H. Gerdes: Developing Applications to Automatically Grade Introductory Visual Basic Courses (2017, at https://core.ac.uk/download/pdf/301371932.pdf); Matt Kusner et al.: “From Word Embeddings to Document Distances”, ICML (2015, available at); and also Marcus Messer et al.: “Automated grading and feedback tools for programming education: A Systematic Review”, ACM Transactions on Computing Education, 24(1): 1-43 (2024 at https://www.twistedsquare.com/GradingSLR.pdf), but that focus was on grading.

Because machines also generate text nowadays, the naturalness (the closeness to human generated text) of the machine generated text is also important. In this context, the Mauve approach from Krishna Pillutla et al.: “Mauve: measuring the gap between neural text and human text using divergence frontiers,” Advances in Neural Information Processing Systems 34:4816-4828 (2021, preprint at https://arxiv.org/pdf/2102.01454) is proposed, along with its improvement from Tiago Pimentel et al.: “On the usefulness of embeddings, clusters and strings for text generator evaluation”. CLR 2023 (2022, preprint at https://arxiv.org/pdf/2205.16001).

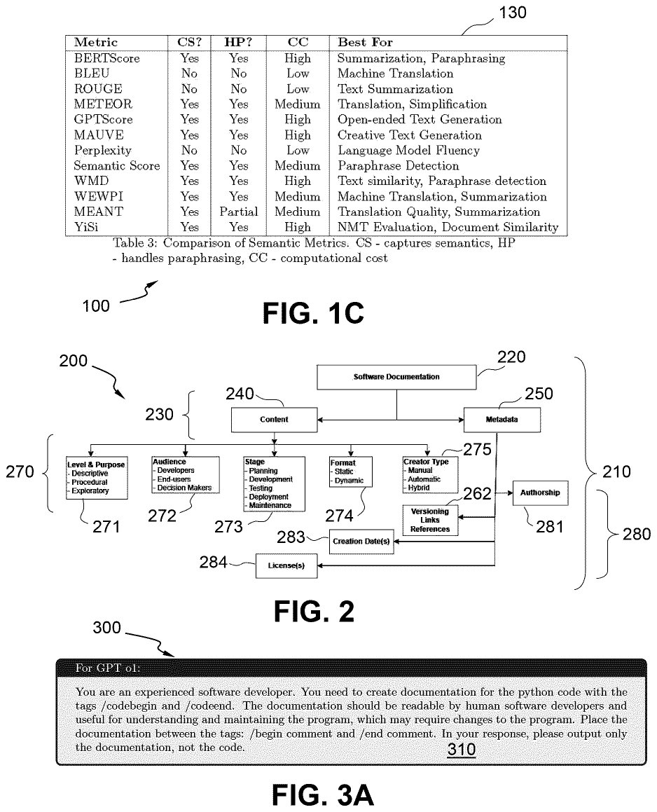

Flowchart—FIG. 2 shows a block diagram view 200 of Software Documentation Analysis flowchart 210: This begins with the documentation 220, which divides into sections 230 context 240 and metadata 250. The content 240 further divides into portions 270 as level & purpose 271, audience 272, stage 273, format 274 and create type 275. The metadata 250 subdivides sequentially into portions 280 as authorship 281, monitoring links 282, creation dates 283 and licenses 284.

For descriptors of content 240, level and purpose 271 includes descriptive, procedural and exploratory characteristics. Audience 272 comprises developers (who write auxiliary code), end-users (who operate the tools) and decision-makers (who determine follow-on capabilities). Stage phase 273 includes planning, development, testing, deployment and maintenance of the associated software. Format 274 divides into static and dynamic forms. Creator type 275 for documentation can be produced by manual, automatic or hybrid efforts.

For identifiers for metadata 250, authorship 281 specifies the person or entity responsible for creation of the textual material memorialized in a permanent record, versioning links and references 282 for cross-reference, creation dates 283 for establishing chronological sequence of revised versions, and licenses 284 for memorializing negotiated rights in software execution and/or development.

Taxonomy—The taxonomy for software documentation is categorized into the following dimensions:
Level and Purpose 271
Audience 272
Stage 273
Format 274
Creator Type 275

Level indicates the document locus, such as entire system subsystem, function, etc. Purpose refers to documentation for description, procedure and exploration. These involve respective details as to the software's function, techniques for achieving specific tasks, and debugging investigation. Audience includes developers, end-users and decision makers. Developers focus on code-level understanding for producing references and programming guides. End users typically involve non-technical or non-expert operators of software. Decision-makers require high-level insight for business strategy.

Stage 273 sequences from Planning, Development, Test, Deployment and Maintenance. Planning involves requirement specification and feasibility studies. Development produces design documents and version control. Test involves evaluation execution and reports of “bug” errors. Development deploys manuals. Maintenance includes patches and updates. Format includes static documentation that remains immutable after creation (e.g., PDF manuals), and dynamic documentation that is continuously updated (e.g., online repositories). Creator type denotes: Manual authored by an individual or teams, Automatic generated by tools (e.g., Javadoc); and Hybrid by a combined manual and automatic effort.

Previous Surveys on Documentation Quality Assessment-Zhi et al. investigated the literature published between 1971 and 2011 and identified fourteen quality attributes. Subsequently, Pooja Rani et al . . . “A Decade of Code Comment Quality Assessment: A systematic literature review”, Journal of System Software 195:111515 (2023, at https://www.zora.uzh.ch/server/api/core/bitstreams/d334008c-edd0-46a0-a1c1-0732ef1a037d/content?trackerId=701448d8d8ff00a) conducted a systematic literature review of software documentation quality assessment in which they collected over two-thousand papers that appeared over a ten-year period (January 2011 to December 2020).

Rani et al. further list twenty-one quality attributes, which include:
a) most studies in their review focused on comments in Java code, which calls their generalizability to other languages into question, and
b) the analyzed studies focused on four main quality attributes with consistency between comments and code being the clear favorite.

They also found that giving checklists to human evaluators was the most popular assessment method for software documentation quality.

Taxonomy for Software Documentation-Software documentation 220 can be categorized into content 240 and meta-data 250. The meta-data 250 include information such as the author(s)/creator(s) of the documentation, the date(s), the license information, and any other pertinent information such as links or references. The content 240 depends on the level of this documentation, e.g., method, class, package, etc., the goals of the documentation, and its intended audience. Inspired by the literature on software documentation, e.g., David Lorge Parnas: “Precise documentation: The key to better software”, The Future of Software Engineering, Sebastian Nanz, ed., 125-148, Springer (2010), this disclosure proposes a software taxonomy.

Standalone Software Documentation Metrics-Software documentation metrics can be categorized into: quality attributes, quantitative metrics, usability metrics, evaluation approaches and life-cycle metrics. Quality attributes include:
Accessibility: the extent to which the documentation is easily retrieved or accessed.
Clarity: readability, coherence, and absence of ambiguity.
Completeness: coverage of all necessary information. This quality is difficult to measure absent some specification of what defines necessary information or a complete specification. In the absence of a specification, one can define completeness of the documentation with respect to the code by:
Accuracy: Correctness and relevance of the information.
Consistency to standard/format: uniformity in terms, structure, and formatting. Does the documentation conform to a standard specified by any external authority?
Consistency: Is the documentation self-consistent in content and format?
Redundancy: Is there unnecessary repetition?
Conciseness: Even if there is no redundancy, the documentation could be verbose and expansive.
Trustworthiness: the extent to which developers perceive the information as trustworthy.
Usefulness: Is the documentation useful for a given task or set of tasks?
Updatedness: Does the documentation accurately represent the current state of the code?
Format/Organization: This refers to the writing style and the organization of the documentation.

### Quantitative Metrics Include:

Size Metrics: length, number of sections, word/token/character counts.
Structural Metrics: number of links, index terms, and cross-references.
Content Metrics: frequency of updates, percentage of obsolete content.

### Usability Metrics Include:

User Satisfaction: surveys, feedback scores.
Learnability: time to understand.
Task Efficiency: time to complete a task using documentation.

### Evaluation Approach Includes

Manual: expert reviews, user surveys.
Automated: tools to assess readability, dead links, or outdated sections.

### Lifecycle Metrics Include:

Development Phase: change frequency, contribution rates.
Testing Phase: bug coverage, traceability matrix.
Maintenance Phase: update frequency, relevance of new content.

Tools for Measuring Software Documentation Metrics-Several tools and platforms are available to measure software documentation metrics. These tools evaluate various aspects of documentation, such as quality, usability, completeness, and maintainability, using automated analysis or manual feedback mechanisms. A list of tools categorized by their focus and functionality are presented below:
Readability and Quality Assessment Tools
Automated Documentation Generators
Content Analysis Tools
Collaboration and Feedback Platforms
Code and Documentation Linter Tools.
Traceability and Lifecycle Tools
Usability Testing Tools
General Analytics Tools

Quality assessment tools include Flesch-Kincade Readability Tests, Microsoft Word, Lix Index (for non-native speakers), C4RLLaMA—operating a large language model (LLM) to check code comment inconsistencies and DMOSS that produces a report. Automated documentation generator include Doxygen for API structure, Javadoc for Java code, Swagger/OpenAPI for API completeness and Sphinx for Python. Content analysis includes Docfx for static documentation websites and GitAnalytics that tracks updates, contribution rates and code coverage by repository documentation.

Collaboration and feedback platforms include Confluence that tracks user engagement, Discourse/Forums that tracks user questions and interactions, and Survey Tools such as Good Forms or Typeform for collecting user satisfaction. Code and Linter Tools include Vale that lints documentation for style and consistency, SonarQube for measuring software quality and safety, Pylint for code error checking and Markdownlint for checking markdown files.

Traceability tools include JIRA to track requirement alignment with documentation, TestRail to link test cases and documentation and ReqIF Studio to manage requirements and track coverage. Usability test tools include Hotjar for tracking user interactions with documentation pages, Crazy Egg to analyze user navigation on documentation sites and Usability Hub to conduct user surveys. General tools include Google Analytics to track engagement on documentation and Matomo as an open-source alternative.

Metrics that Compare Code with Documentation—The literature is reviewed on comparing code with the associated documentation. There are Several works on detecting code and comment inconsistencies, e.g., Guoping Rong et al.: “Code Comment Inconsistancy Detection and Rectification using a Large Language Model”, IEEE/ACM 47^{th} International Conference on Software Engineering (ICSE) (2025, available at https://people.cs.umass.edu/~brun/class/2024Fall/CS692P/idllm.pdf) present C4RLLaMA, which is a fine-tuned large language model (LLM) based on the open-source CodeLLaMA. Moreover, Huang et al. present a learning method called CoCC (presumably denoting Code Comment Consistency) for detecting whether the comments are outdated.

There are very few papers on deciphering the relationship between code and comments. Deze Wang et al.: ‘Deep code-comment understanding and assessment”, IEEE Access 7:174200-174209 (2019, available at https://scispace.com/pdf/deep-code-comment-understanding-and-assessment-5dof1rvs4h.pdf) use a Multilayer Perceptron to assess the quality of comments after code and comments are vectorized using a Bi-LSTM model and the weighted GloVe model respectively. Mingyang Geng et al.: “Fine-grained code-comment semantic interaction analysis”, Proceedings of the 30^{th} IEEE/ACM International Conference on Program Comprehension, 585-596 (2022, available at https://shangwenwang.github.io/files/ICPC-22.pdf) propose FOSTERER to expose fine-grained relationships between the code and associated comments. Given code C and documentation D, the code-generating algorithm is applied to D to produce new code C′, the idea being that for documentation determined to be sufficient to reproduce the original code, then that documentation is deemed “good” for this purpose.

Several issues must be addressed in using this technique. First and crucially, the documentation must not be a literal reproduction of the code. As noted above, documentation must aid in the understanding and maintainability of the code, and simply reproducing the code “in English” vernacular is of no value, as noted by Pillutla et al. Second, there are many ways to perform the same function in any given computer language, and so the documentation need not reproduce the code literally, but instead produce equivalent code. Techniques to compare the two code examples are needed to provide the metrics for this approach. A survey of code comparison methods is beyond the scope of this disclosure. A third issue is that of readability issues such as clarity, non-redundancy and trustworthiness.

While these are relevant to whether the code-generator can “understand” the documentation well enough to produce correct code, the code-generator is not the end user, and operators may require very different information than an LLM or other code-generation algorithm. Finally, there are use cases for documentation unrelated to reproducing the software, such as those measured by lifestyle metrics.

Metrics for Comparing Automatically Generated Documentation with Developer-Written Documentation—Below is a list of metrics used to compare auto-generated documentation with developer-authored documentation, along with relevant citations and tools for measurement:
Completeness: This measures how much functionality described in the developer documentation is captured in the autogenerated documentation. Tools include Swagger and Doxygen.
Consistency: This evaluates similarity in terminology, formatting, and content structure. Tools include Vale, C4RLLaMA and Grammarly.
Accuracy: This checks for errors or discrepancies in the auto-generated documentation. Tools include Swagger and Javadoc.
Readability: This assesses the readability and comprehensibility of the auto-generated documentation. Tools include Readability and Grammarly.
Redundancy: This evaluates unnecessary or repeated information in the auto-generated documentation, typically involving custom scripts or manual review.
Coverage: This measures how much of the codebase is documented in the generated documentation compared to the developer-written documentation. Tools include Javadoc and Doxygen.
Usability: This measures how easily developers and end-users can utilize the documentation for debugging and understanding purposes. Tools include Hotjar and Crazy Egg.
Update Frequency: This compares how frequently auto-generated documentation and developer-written documentation are updated to reflect codebase changes. Tools include GitAnalytics and JIRA.

Metrics for Object-oriented Design—The following metrics were proposed by Shyam R. Chidamber and Chris F. Kemerer: “A Metrics Suite for Object Oriented Design”, IEEE Transactions on Software Engineering 20(6): 476-493 (1994, available at https://www.eso.org/~tcsmgr/oowg-forum/TechMeetings/Articles/OOMetrics.pdf) for object-oriented design:
1. Coupling: this refers to the degree of interdependence between parts of a design. Let X and Y be any two objects. X is said to act upon Y f the history of Y is affected by X, where history is defined as the chronologically ordered states that a thing traverses in time. Similarly, one can define coupling between classes.
2. Cohesion: this refers to the internal consistency within parts of a design. Cohesion is defined in terms of similarity. The similarity of two methods is defined to be the intersection of the sets of instance variables that are used by the methods. “The degree of similarity of methods can be viewed as a major aspect of class cohesiveness.”
3. Complexity of an object: this is based on Bunge's definition of complexity of an individual as the “numerosity of its composition,” which means that a complex individual has a large number of properties. Complexity of an object class is the cardinality of its set of properties.
4. Scope of properties: this refers to how far the influence of a property extends. It is captured by the depth of inheritance of a class of objects in the inheritance tree, i.e., the length of a maximal path from the class to the root of the tree, and the number of immediate descendants of the class in the inheritance tree.
5. Methods as measures of communication: this is defined using the response set of a class of objects as the set of all methods that can be invoked in response to a message to an object of the class.
6. Combination of object classes. If X and Y are two object classes, then X+Y is defined as a new token Z whose property set is the union of the property sets of X and Y. The property set of an object class X is the union of the sets of its methods and its instance variables. Their combination results in a single joint space of instance variables and methods instead of two separate spaces, and all prior messages between the two component classes are erased.

Metrics Evaluation Criteria—Some researchers have recommended properties that software metrics should possess to enhance their utility. Victor R Basili and David M Weiss: “Evaluation of a Software Requirements Document by analysis of change data”, ICSE 81, 314-323 (1981, available at https://apps.dtic.mil/sti/pdfs/ADA160202.pdf) suggest that the metric should be sensitive to externally observable differences in the development environment and must also correspond to intuitive notions about the characteristic differences between the software artifacts being measured. The majority of recommended properties are qualitative in nature and consequently, most proposals for metrics have tended to be informal in their evaluation of metrics. To move metrics research into a more rigorous footing, a formal set of evaluation criteria for metrics is desirable.

Elaine J. Weyuker: “Evaluating Software Complexity Measures”, IEEE transactions on Software Engineering 14(9): 1357-1365 (1988, available at https://www.researchgate.net/profile/Elaine-Weyuker/publication/3186968_Evaluating_software_complexity_measures_IEEE_Trans_Softw_Eng/links/0a85e533312f00e01f000000/Evaluating-software-complexity-measures-IEEE-Trans-Softw-Eng.pdf) has developed a formal list of desiderata for syntactic software complexity metrics. Weyuker has also evaluated a number of existing software complexity metrics using these properties, as documented by Yoshua Bengio et al.: “A Neural Probabilistic Language Model”, Journal of Machine Learning Research 3:1137-1155 (2003, available at https://jmlr.org/papers/volume3/bengio03a/bengio03a.pdf).

These desiderata include:
1. nontriviality (there are at least two programs of different complexity according to the metric),
2. finiteness (there are only finitely many programs of the same complexity, the assumption is that there is only a finite supply of identifiers and there is an upper bound on the length of any instruction),
3. monotonicity (complexity does not diminish if two programs are composed together)—see Messer et al.,
4. interaction (defined below),
5. invariance under renaming (if P is a renaming of Q, then |P|=|Q|),
6. nonuniqueness (there are at least two distinct programs of the same complexity),
7. sensitivity to permutation (program complexity should be responsive to the order of the statements, and hence the potential interaction among statements),
8. the whole being sometimes bigger than the sum of the parts (at least in some cases); the complexity of a program formed by concatenating two program bodies being greater than the sum of their complexities. (This reflects the fact that there may be interaction between the concatenated subprograms.), and
9. implamentation dependence. (There exist semantically equivalent programs of different complexity.) Interaction is defined as context dependence |P| denotes the complexity measure of program P) |P|=|Q|:
   a: (∃P)(∃Q)(∃R)|P|=|Q|\hat{ }|P; R|≠|Q; R|,
   b: (∃P)(∃Q)(∃R)|P|=|Q|\hat{ }|R; P|≠|R; Q|.

Criticisms of Weyuker's properties are noted in Chidamber et al., with citations to several critiques. These critiques include:
The properties do not adhere to a consistent definition of complexity.
They do not scale.
They only provide necessary, but not sufficient conditions for complexity metrics.
   However, the properties are part of a formal analytical approach that is widely used in theoretical computer science. Metrics on principles for abstract meaning representation similarity have been set forth in Huang et al.

Summary of AMR Similarity Metrics from Principles—Juri Opitz et al.: “AMR Similarity Metrics from Principles”, Transactions of the Association for Computational Linguistics (2020, available at https://aclanthology.org/2020.tacl-1.34.pdf) discuss evaluating Abstract Meaning Representation (AMR) graphs using different metrics. Opitz et al. establish a principled framework for assessing metrics and propose a new metric called S2match. Definitions are introduced herein.

Definition 1. A program or code (notations P or C) in a programming language L is a well-formed string (that follows the rules of L) over the alphabet of L, which is executable on a computer. A documentation (notation D) in a natural language NL is a well-formed string over the alphabet of NL, which describes the goals, properties and assumptions of a program or code.

Definition 2. A code generator CG is a program (or human) that is given a task/requirement specification S that includes specification of a high-level programming language L (e.g., C, C++, Java, python) for which code is desired, and outputs corresponding code C(S) in L whenever the input task(s) is (are) computable, and well defined by S.

Equivalence of Programs and Documentation Metrics—Two segments of code are deemed equivalent provided that they obtain the same data as input and compute the same relationship between inputs and outputs. In such a case, the two programs are semantically equivalent (under notation ~ₛ). Although, semantic equivalence of programs is undecidable in general, there are a variety of formal methods that can help in practice such as theorem proving, model checking, and symbolic computation. Given a set of empirical tests, T, such as a fixed set of input-output pairs, unit tests, the equivalence of some derived graph(s) such as the Abstract Syntax Tree (AST), etc., we define two codes to be empirically equivalent (notation ~_{e(T)} or ~ₑ if T is understood) if they produce the same values on the given set of empirical tests. Semantically equivalent codes are empirically equivalent for the test set T consisting of all possible input-output pairs.

Given certain pragmatic measures of code such as the number of steps (“time”) of execution or the memory consumed, we define two codes as pragmatically equivalent (notation ~ₚ) if they yield the same pragmatic measures of interest. Here “inputs” and “outputs” should be considered inclusively. In particular, any environmental factors that impact the code (such as aspects of the computing environment, memory, files, etc. in which it operates) and any side effects that may be produced.

Definition 3. Software documentation (or documentation for short) is defined as any artifact that helps to communicate information about a software system among stakeholders (e.g., requirement engineers, and developers). Let C be a piece of code in any high-level programming language. A documentation generator DG is any program that takes C as input and outputs its documentation. A code generator is any program that employs documentation (or the specification of a problem to be solved) as input and outputs corresponding code C′.

In the above definition, the specific form of equivalence depends on the desired purpose. For theoretical considerations, one might specify semantic equivalence, but for practical purposes, empirical will almost always be the equivalence of choice. One can now define completeness of a piece of documentation based on the existence of at least one documentation generator that can produce equivalent code.

Definition 4. Completeness: A piece of documentation D is complete for code C provided there exists a code generator G which when given D produces code C′ with C′~ₛC. It is empirically complete if C′~_{e(T)}, and pragmatically complete if C′~ₚC. In some situations, one can relax the notion of completeness by using semantic equivalence rather than pragmatic equivalence. This enables redundancy of a piece of documentation to be recognized.

Definition 5. Redundancy: Documentation D is considered semantically redundant if there is a word subsequence such that C(D)~ₛC(D′). Similarly, documentation D is empirically (pragmatically) redundant if there is a substring D′ of D such that C(D)~ₑC(D′) (C(D)~ₚC(D′). In practice, testing for redundancy can be extremely computationally intensive because there are exponentially many word subsequences of a sequence. Hence, two options are proposed:
a) remove one line of documentation and see if the resulting documentation is still complete. If one can remove a line and get “as good as” the original, then the original is redundant. One can remove each line in turn and perform this check, which gives a linear time solution to determine whether documentation D is redundant or not. Note it does not give a linear time solution to finding a non-redundant documentation which is complete for the associated code. It merely informs that D is redundant (we choose line here, but we could do this with every word as well).
b) The second option is to approximate this using a binary search technique. This binary search proceeds by asking whether there is an (abstractive) summary of documentation D of code C of half the length, i.e., |D|/2 which is semantically or empirically complete (whichever notion is desired). If not, we repeat the search with the interval [|D|/2, D]. If yes, one can try the interval [1, |D|/d]. For constructing the summary, two options can be considered: an LLM calling a summarizer or directly using a summarization tool. Based on empirical evidence, LLMs have not shown that they can stay within a given budget of words. A purist would say that this really measures a documentation's conciseness not redundancy. How “up-to-date” for a piece of documentation would be next, i.e., there exists a documentation generator that can produce code that is semantically and pragmatically equivalent to the current state of the code.

Definition 6. Documentation D is considered up-to-date provided there exists a documentation generator G such that given the current documentation D accompanying code C produces code C′ that is semantically and pragmatically equivalent to code C. As in computational complexity theory, one can insist on all our texts (programming or natural) to be reasonable, i.e., no unary encoding for numbers and words, and no unnecessary padding, spaces or junk to make things needlessly long. One can define the length (or size) of documentation as the number of characters (letters, digits, or punctuation marks including spaces and newline characters). Now, one can define the complexity of a piece of code C as the shortest documentation D that enables one to generate code that is semantically and pragmatically equivalent to C.

Definition 7. The complexity of a piece of code C is the shortest documentation D such that there is a code generator G that when given D produces code C′ which is semantically and pragmatically equivalent to C. The above definition should be compared with the Kolmogorov complexity of a string, which is defined as the length of the shortest program that outputs the string. One can define consistency of a software system based on whether the documentation enables derivation of a contradiction using the program and the documentation as formulas in a logic that is sufficiently expressive to represent the code and documentation. A word subsequence is obtained by deleting some words of a sequence.

One now defines maintainability of a software system, i.e., code and documentation, based on the existence of an agent who can modify the code to accomplish a task. An “open-ended” definition of maintainability is a vague concept. Instead, maintainability can be defined with respect to a given finite set of tasks T. Examples of such tasks include removing a bug, porting the system to a new environment, adding a feature to the system, etc. For convenience, one can assume that the given tasks are all independent so that the system starts each time with the original code. In practice, the specific tasks in T cannot all be predicted in advance. However, this actually makes good documentation all the more important, not less. For example, the type of environment needed to port a program to in the future may be unspecified, but one can safely assume (given the rapid advances in hardware, etc.) that a useful ML program, for example, will likely need porting over its deployment cycle, if the cycle is expected to be reasonably long, e.g., more than a couple of years.

Definition 8. A software system SS=(code, documentation) is maintainable with respect to a set of tasks T, if there exists an agent that can produce the proposed modifications to the code component of SS to accomplish the tasks, when given SS and T as inputs. This assumes that the modification tasks are “reasonable,” i.e., they make sense for the given code and do not require a complete rewrite of the code. One can assume that sufficient resources such as memory, etc., are available to accomplish the modification and that programmer effort is measured in units of time expended on writing code. To define a reasonable modification, given a set of agents A, one requires that:
i) there is at least one agent a∈A that can accomplish the modification with less effort E than writing the target program Pₜ from scratch, i.e., E(Pₜ|C)<E(Pₜ|Ø), and
ii) C∩Pₜ=C′, so that C″ is a well-formed nonempty subprogram of C and Pₜ. If A is not specified, then one requires at least one agent that satisfies this inequality.
   This definition also enables one to define self-documenting code by setting the documentation component of the system to null (in practical terms, the documentation is removed). More importantly, one can also determine whether the documentation improves the maintainability of the code. One can consider the effort required to make a modification to the code with and without the documentation when given an objective.

Definition 9. A task is deemed trivial, when an agent can produce the modification required by the task with no more effort when the documentation is stripped from the code. For a trivial task, documentation becomes unnecessary. For a code that is truly “self-documenting”, all tasks are trivial.

Definition 10. Given a software system SS=(C, D) and a nontrivial task T, the documentation is deemed helpful for T provided an agent exists whose total effort in making the proposed modification is reduced when given the documentation versus when given only the code, i.e., E (Pₜ|C,D)<E(Pₜ|C). How to measure the reduction in effort for a nontrivial task? For trivial tasks, the documentation may end up increasing the effort for every agent that does not ignore the documentation, as some effort (time and energy) is expended in understanding the documentation. One can also assume that the agent works diligently and does not waste any time in either scenario (just the code and code+documentation). But such measurement in effort reduction due to the difficulty of finding two equivalent humans in ability and in intelligence. The same human cannot perform in both scenarios, because some learning effect could confound the experiment.

Of course, one can perform experiments with groups of software developers of “roughly equivalent” experience, in which each is given either code or code plus documentation, and compute the time to complete the tasks (and any other measures of interest), comparing those with only the code to those who also have the documentation. Instead, the use of two local LLMs is proposed, either is a clone of the other, in closed environments with frozen parameters (e.g., no communication with a central server or one another) and are given identical tasks to execute with one being provided only the code and the other provided both code and documentation. The task T is carefully designed to be easier to carry out with the documentation than without. For this purpose, a synthetic suite of tasks of varying levels of difficulty can be built by increasing the number of modifications to the code that are to be made as part of the task. The second condition excludes cases where the entire code C is mangled in the target program, but the effort reduced is that of typing some characters because they were supplied by C.

It is important to distinguish the documentation from the code. For example, string constants that are never actually accessed by the code can be used as a method of commenting the code. This is not considered to be “self-documenting code” but rather a redefinition of “comment”. In this case, “setting the documentation to null” means removing these constants from the code. For example, a simple but nontrivial task could be that a line of code has been mistakenly indented so that it is outside the loop in a Python program, which contains more than one loop. The documentation indicates that a counter is incremented in a specific loop helping narrow the focus to the correct loop. Another simple but nontrivial task is of a mistakenly made variable substitution in a parameter list. If the documentation has the names and types of parameters for every function declaration, then the substitution is easier to catch with the documentation. One can combine such tasks to get new tasks that are harder. Effort can be measured in several ways for open LLMs. For example, the number of activated neurons, the wallclock time, the energy consumption, etc.

Definition 11. The effectiveness (or usefulness) of a piece of documentation D for a piece of code C with respect to a given task T is the reduction in effort as specified above. This is easily generalized to a set of tasks T by aggregating (e.g., summing) the reductions for all the tasks in the set. Comparing documentations for the same piece of code. One can compare two documentations D and D′ for the same code C given a fixed set of tasks T as the total reduction in effort using D versus the total reduction in effort using D′. One can anticipate that for some tasks the code C may not be necessary, whereas for others it may be required. The raw power of D versus D′ can be exhibited by choosing the tasks carefully so that C is not necessary and making sure not to provide it to the agent(s). Comparing documentations for different pieces of code. For this purpose, one can consider various types of agents such as a human programmer, an LLM or the simplest types of agents possible. One choose the latter option, i.e., agents as simple neural networks that can perform the task(s). Hence, consider neural networks as graphs, G=(N,S), where N is the set of neurons and S is the set of their connections. Let |N| denote the size of a neural network N. Now, one can choose the nontrivial tasks in such a way so as to non-redundantly “cover” the documentation in analogy with how unit tests/tests are chosen so as to cover the code. One then looks for the simplest (e.g., smallest in size) neural network that can carry out each nontrivial task successfully when given the code and documentation. Let this network be denoted by N(t) where t is any nontrival task. This can be used to quantify the potential of documentation as follows. |D|.

Definition 12. Given a set of tasks T and a software system SS=(code C, documentation D), one can define the potential of D as

$$\frac{\vert D \vert}{{\sum }_{t ∈ T} \vert N ( t ) \vert} .$$

The units are words (or characters) per graph object o. Given two software systems presumably with the same (or similar) goals, e.g., two different sorting algorithms with their own documentations, and a standard set of tasks T, one can compare the two documentations in quality by first picking a minimally powerfully LLM as a standard neural network for carrying out the tasks in T, then one can compare the effectiveness of documentations across the two software systems directly. There is also the option of comparing the documentations based on their potential. If one can standardize the tasks, then even the documentations of radically different software systems, i.e., systems with very different goals, could be compared based on their potential. Equivalence of Documentations and Metrics for Code—One can now define the semantic and pragmatic equivalence relations on the set of documentations using a precise approach. One can consider two documentations semantically equivalent provided that their content when converted to precise documentation forms are logically equivalent. Let P denote the function that transforms document (short for documentation) D into its precise form, P (D).

Definition 13. Documents D, D′ are semantically equivalent D!~ₛD′, provided P(D) is logically equivalent to P(D′). A document has a form and structure (the syntax, which is governed by the rules of the underlying language), content and metadata, e.g., authors, date, copyright, etc. For semantic equivalence, we restrict the definition to content of the documentation only. The pragmatic considerations for documentations could be their readability, utility, their metadata, or considerations derived from their syntax, etc. One can also define empirical equivalence of two definitions by focusing on a set of content-based questions, i.e., ruling out questions such as whether two documents have the same length. Two documents are empirically equivalent provided that they have the “same” (logically equivalent) answers for content-based questions. Pragmatic equivalence focuses on pragmatic items of interest. One can now define completeness of generated code. Effectiveness is negative, if there is an increase in effort instead of a reduction.

Definition 14. Completeness: A piece of code C is complete for documentation (precise form) D provided there exists a documentation generator DG, which when given C produces documentation (precise form) D′ with D′~ₛD. It is empirically complete if D′~_{E}(T)D, and pragmatically complete if D′~ₚD.

Code and Documentation Duality: If one compares Definitions 4 and 14, one can observe a duality between code and documentation in its precise form. Using this duality, one can now define many other automated metrics and associated algorithms for measuring them. Given metric spaces X and Y and maps (or AI/ML algorithms such as LLMs and others) f: X→Y and g: Y→X, consider the problem of determining the effectiveness (quality, reliability, etc.) of f. Traditionally, one compares f(x) with “truth” values y∈Y. In addition to this traditional method, we propose the following, which does not require ground truth: compute d(x, g (f(x))). That is, map back to X and determine whether the result is “close to” the original. This is applicable to many generative Al problems. For example: document summarization (which code-commenting can be considered as a variant of); code generation, which is simply swapping f and g in our framework; image generation—X corresponds to a description of the image, and g to a captioning or description of the image. Translation of natural language text or programs from one programming language is naturally captured by this framework. For the C→D→C′ pipeline, LLMs have been used extensively for code documentation. Thus the exemplary methodology employs LLMs as documentation and code generators.

Principles Introduced: Allow A, B and C to be AMR graphs. Also, let us assume our co-domain is a subset of the real numbers. The following principles are introduced to guide the evaluation of AMR similarity metrics:
1. Continuity, non-negativity and upper bound: There should be both a maximum and a minimum bound for similarity. For the case where A=B and the case where A and B are unrelated, respectively.
2. Identity of Indiscernables: Metrics should assign the maximum score to and only to semantically equivalent AMR graphs.
3. Symmetry: metric (A, B)=metric (B, A)
4. Determinacy: If it is once true that metric (A,B)=z where z∈ [symbol] , it should always be true that metric (A,B)=z.
5. No bias: A metric should not unjustifiably or in unintended ways favor correctness or penalize errors for specific substructures.
6. Graph matching-symbolic perspective: If A and B are more similar than A and C, the proportion of similar triples between graphs A and B is greater than the proportion of similar triples between graphs A and C.
7. Monotonicity: Scores should decrease consistently as semantic divergence increases.
8. Robustness to Surface Variations: Metrics should avoid being overly sensitive to minor syntactic or structural differences that do not affect semantics.
9. Computational Feasibility: Metrics should balance theoretical soundness with practical applicability.
10. Meaningful Feedback: Metrics should provide interpretable results to help researchers identify areas of semantic alignment or misalignment.

Evaluation of Existing Metrics—Opitz et al. evaluate two metrics Smatch and SemBleu.
Smatch: (a) Description: a canonical metric that aligns variables in two graphs and measures triple matches. (b) Strength: well-established and widely used. (c) Weakness: computationally intensive due to variable alignment.
SemBleu: (a) Description: Inspired by BLEU (a machine translation metric), this avoids variable alignment for faster computation. (b) Weakness: violates the Identity of Indiscernables principle and introduces biases in scoring.

Proposed Metric—S2match is described as a novel metric combining the strengths of Smatch and SemBleu, while adhering to the proposed principles. Its advantages include: (a) Conforms to all the established principles. (b) Provides a balanced evaluation of AMR similarity. (c) More tolerant of minor semantic deviations and computationally efficient.

Academic Community's Perspective—The academic community has generally appreciated the principles outlined in the paper for their rigor and practical relevance:
Positive Reception: (a) The principles address long-standing concerns about evaluating semantic graphs effectively. (b) The proposal of S2match provides concrete improvements for AMR evaluation methodologies.
Critical Feedback: (a) Implementing these principles in real-world applications requires further refinements. (b) Broader testing of S2match across diverse datasets is necessary to assess its robustness.
Future Research Directions: (a) Extending these principles to evaluate other meaning representations, such as dependency trees or frame semantics. (b) Optimizing computational efficiency without sacrificing accuracy.

Mostly Comparative Metrics-Many of the metrics from text-to-text comparison can also be applied to software documentation and code comparisons. Hence, the survey by Sai et al. provides a more comprehensive list of metrics that have been used to evaluate NLG systems. Symmetric metrics are emphasized, i.e., metric (A, B)=metric (B, A) for all texts A and B, and/or preservation of semantics rather than syntax of the texts being compared. Evaluating machine-generated text requires robust semantic metrics that go beyond simple string matching. Various metrics have been developed to assess fluency, coherence, and meaning preservation in generated text, such as for BLEU by Kishore Papineni et al.: “Bleu: a method for automatic evaluation of machine translation”, Proceedings of ACL, 311-318 (2002, available at https://www.cs.columbia.edu/nlp/sgd/bleu.pdf) and BERT by Tianyi Zhang et al.: “BERTscore: Evaluating text generation with BERT” (2020 preprint at https://arxiv.org/pdf/1904.09675). FIG. 1C in Table 3 lists Text Comparison Metrics.

Pitfalls of Metrics-David Gros et al.: “Code to Comment “Translation: data, metrics, baselining & evaluation”, Proceedings of the 35^{th} IEEE/ACM International Conference on Automated Software Engineering, 746-757 (2020, available at https://www.cs.ucdavis.edu/~devanbu/code_comm_trans.pdf) expose some of the pitfalls of using text metrics such as BLEU to evaluate the quality of generated comments with respect to manual documentation.

However, some of the potential sources of ambiguities are common to other types of metrics as well. Hence, these are discussed in a separate section. First, token-level metrics such as BLEU are sensitive to the tokenization method used. Second, methods that combine scores that could be zero (e.g., BLEU typically considers unigrams to 4-grams and computes precision for each of them and one of them could be zero) are sensitive to the smoothing technique used. Third, authors typically do not explain whether they are using Corpus versus Sentence level metrics. The Corpus level means that the computation of the score is done lazily after aggregating all the information from the entire corpus. In Sentence level, the score is typically calculated for each sentence separately and the arithmetic mean is computed to aggregate all the scores. The last source of ambiguity could arise with other metrics as well. The comparative metrics include normalized information distance from Paul M. B. Vitanyi et al.: “Normalized Information Distance”, Information Theory and Statistical Learning, Frank Emmert-Streib, eds., 45-82. Springer (2009, preprint at https://arxiv.org/pdf/0809.2553). This is a general measure that can be applied to compare two programs or two documents.

In this disclosure, a taxonomy of software documentation has been provided along with categorized software documentation quality metrics. Then, documentation quality metrics have been surveyed, and tools for organizing and measuring some of the metrics have been proposed. Principles have been highlighted for metric evaluation that have been put forward and then discussed, which of the mathematical metrics satisfy some of the basic properties. Three sources of ambiguities arising in the reporting of metrics have been reviewed.

Further quantification of comparison metrics between software and documentation are available through other mathematical indices. For example, Levenshtein Similarity LS is defined as:

$$LS ( x , y ) = 1 - \frac{L D ( x , y )}{max ( \vert x \vert , \vert y \vert )} , \qquad ( 1 )$$

where LD(x, y) is the string edit distance from x to y. Jaccard Similarity JS is defined as:

$$JS ( A , B ) = \frac{\vert A ⋂ B \vert}{\vert A ⋃ B \vert} , \qquad ( 2 )$$

where A and B are the sets of tokens obtained from the lists of tokens, using the split method from the two programs. Cosine Similarity CS is defined as:

$$CS ( x , y ) = \frac{x \cdot y}{\vert x \vert \vert y \vert} , \qquad ( 3 )$$

where the vectors x and y are obtained using the frequencies of character bigrams, trigrams and 4-grams from the two programs, as for example Scikit-learn's Count Vectorizer. Jaccard Similarity for Bags JSB is defined as:

$$JSB ( A , B ) = \frac{\vert A ⋂ B \vert}{\vert A ⋃ B \vert} , \qquad ( 4 )$$

where A and B are the sets of tokens obtained by tokenizing, using the split method, the two programs. Multiset intersection uses the minimum frequency of each token in the numerator and multiset union uses the sum of frequencies of each token in the denominator. Example numerical comparisons are presented for various techniques in FIG. 1D as Table 4.

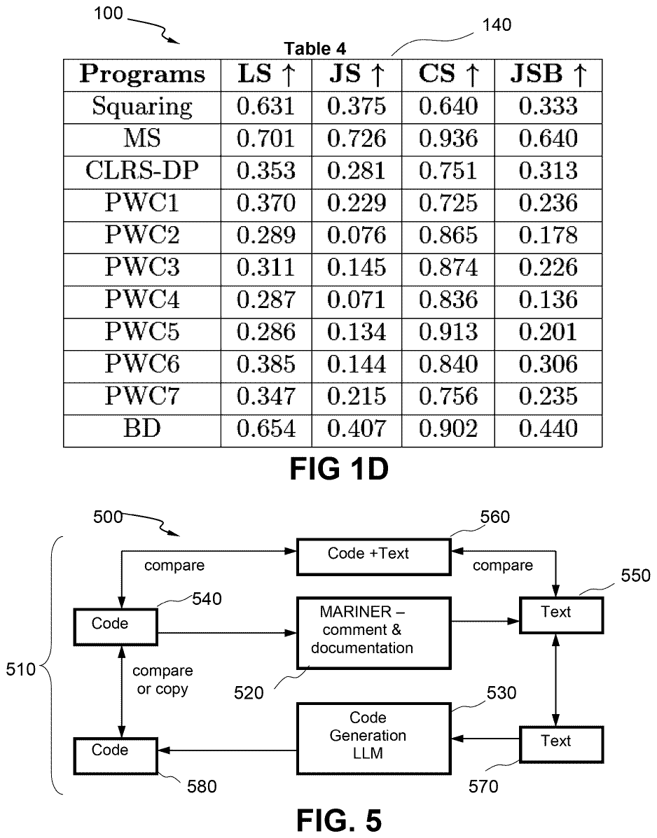

FIGS. 3A and 3B shows a window box view 300 of prompts for developing documentation from code and vice versa. In particular, FIG. 3A instructs 310 GPT to create documentation from Python code, and FIG. 3B tasks 320 Gemini 2 to produce Python code without comment or object-oriented features. The Python code provides machine language instruction to a digital processor for compilation and execution. The documentation describes the intended purpose and functionality of the high-level language code into human-readable form, along with context for improved human interpretation.

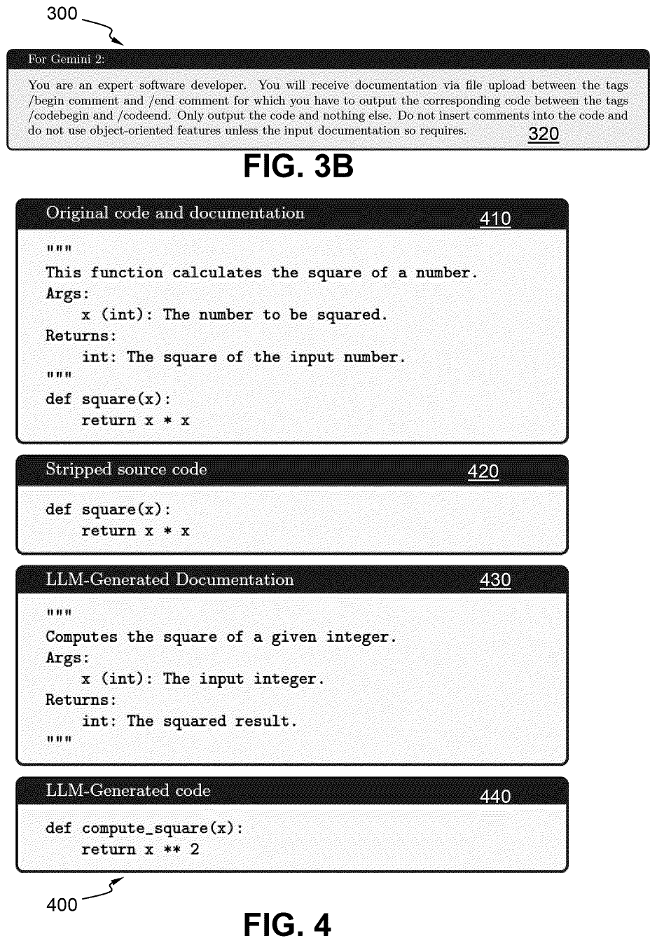

FIG. 4 shows a window box view 400 of an illustrative example in segments for squaring an integer labeled x. Original code and documentation 410 includes both the machine instruction and comments regarding the code's objective by multiplying x*x. Stripped source 420 presents only the machine instruction code. LLM generated documentation 430 provides explanation and commentary based on the code, with similar although not identical to the initial human-generated original 410. Finally, LLM generated code 440 creates the same functionality of the initial code version, albeit slightly differently, by exponential power raising x**2.

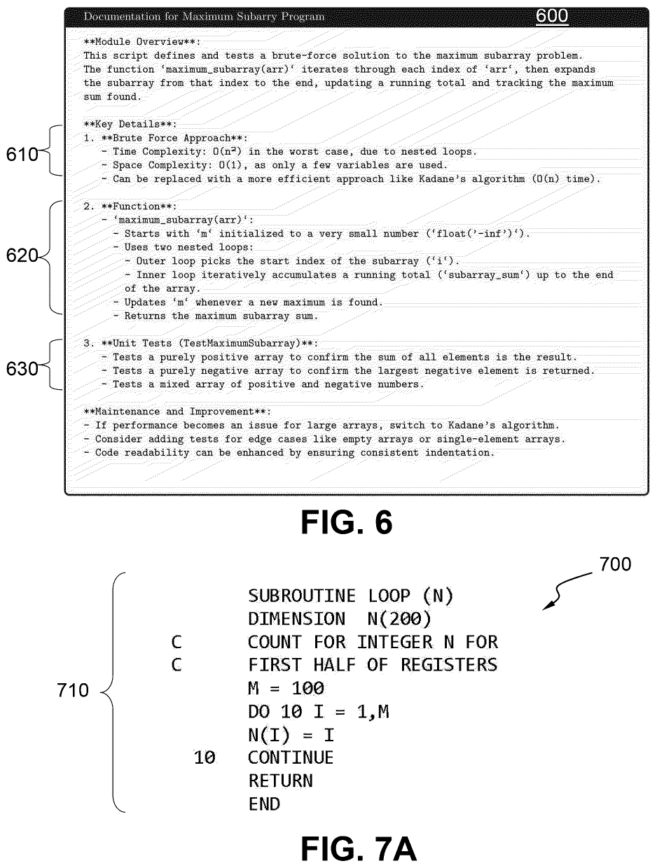

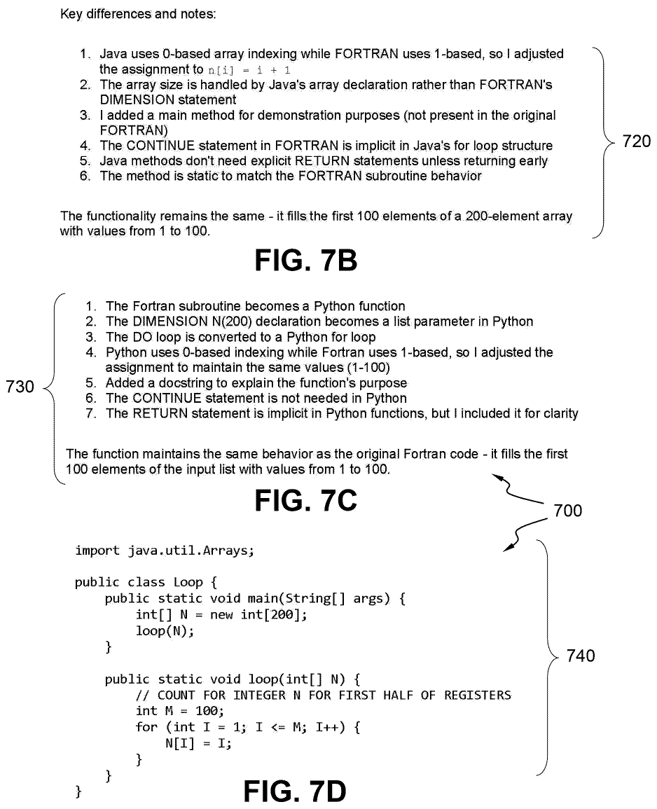

FIG. 5 shows a flowchart view 500 of the pipeline 510 from initial code→documentation →generated code using an analyzer 520, such as MARINER 530 and a code generating LLM 530. An initial code 540 is input, parsed and interpreted by MARINER 530 to produce comment and documentation as text 550. Both code 540 and text 550 are compared 560. The text 550 is copied as text 570 to the LLM 530 to generate alternate code 580. FIG. 6 shows a window box view 600 of documentation for maximum subarray program to iterate each index of an array and track the maximum sum found. The approaches include brute force 610, loop function 620 and unit tests 630.

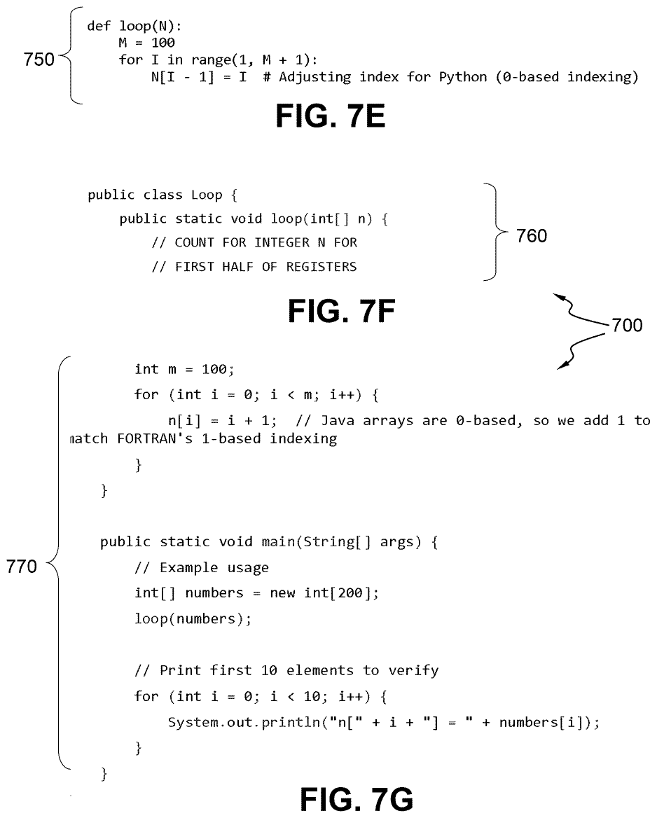

FIGS. 7A, 7B, 7C, 7D, 7E, 7F and 7G show text views 700 for code or documentation for language translation. FIG. 7A provides a Fortran subroutine source code to count the first half of an array of integers and return the array as a dummy variable. FIGS. 7B and 7C present respective documents 720 and 730 regarding translation from Fortran to Java and Python. FIGS. 7D and 7E present respective translated codes 740 and 750 into Java and Python. FIGS. 7F and 7G present respective alternative documentation and code integrations 760 and 770.

The process for evaluating software documentation for purposes of producing an equivalent executable code is based on the flowchart 510 in FIG. 5. Thus the exemplary process constitutes the following operations. An original code is analyzed for based on its instructions to produce a text document that explains its purpose and methodology. This code and its resultant text are compared for accuracy. A large language model (LLM) receives the text and generates a substitute code, which can then be compared.

Standard Notations provide further clarification. Using an appropriate prompt one can produce code C′ from document D using artificial intelligence or a human agent as a Subroutine: GenCode(Doc D). This is required by most of the algorithms and so remains assumed as part of the inputs of the algorithms. The algorithm measures the completeness of documentation from inputs Code C, related Documentation D and a subroutine EQ to determine equivalence of code, which could be functions or entire programs. Assume EQ returns true for the functions/code being equivalent and false otherwise. Many possibilities exist for EQ, e.g., equivalence of code embeddings, unit tests, Input/Output pairs, and theorem proving. Some algorithms require a summarizer (abstractive or extractive) referred to as Summ(T, Len, Unit), which returns summaries of size Len of input text T measured in terms of Unit length, which could be word, sentence, paragraph, etc. For example, a nondeterministic summarization LLM as a tool has the ability to generate multiple summaries of size Len of text T.

These operations can be expressed as follows:
(1) Provide GenCode(Doc D).
(2) Assuming code C is in functional style, one compares functions f of C to functions f′ of C′ for equivalence, i.e., call EQ(f, f′).
(3) Create a bipartite graph G with nodes in first partition corresponding to functions f in code C and nodes in second partition corresponding to functions f′ in code C′. For an edge from f to f′ provide EQ(f, f′)=1 but 0 otherwise.
(4) Find a maximum matching M in the graph G. If |M| equals all the functions f in C, then the documentation covers all functions, otherwise the functions of C that are not matched to any functions of C′ are not covered by the documentation D.
(5) Return D is complete if all functions f in C are covered, otherwise return D is incomplete with percentage of incompleteness measure by percentage of uncovered functions. One can also output two lists of functions of C, those that are covered by the matching and those that are not covered by the matching M. The matching M is also an output of this algorithm indicating the pairing process.
(6) One can enumerate all the maximum matchings of the bipartite graph and collect the set of functions that are not covered by any maximum matching.

For example, let Code C comprise two functions as follows. Documentation D: Program P implements a function to compute factorial(n), when given integer n >0, which is defined as the product n!=n·(n−1)· . . . ·3·2·1 with 0!=1:
(1) Program P
(2) function f (n: integer)
(3) #Assumes n >=0
(4) If (n==0) then return 1 else return n*f(n−1)
(5) Function g (n: integer)
(6) #Assumes n >=0
(7) If (n==0) then 0 else return n+g(n−1).
Then assume that one provides the documentation D with a suitable prompt to an LLM and return code C′ as follows:
(8) Program Computes_Factorial
(9) function factorial(n: integer)
(10) #Assumes n >=0
(11) If (n==0) then return 1 else return factorial(n−1)*n.
Because there is only one function factorial in code C′ one obtains two calls to subroutine EQ with (f, factorial) and (g, factorial) as inputs. Then EQ(f, factorial) returns true and EQ(g, factorial) returns false. The bipartite graph has a maximum matching of size one consisting of the single edge between f and factorial. Hence documentation D is regarded as 50% complete. With function ƒ being covered and function g not being covered. One can extend this algorithm to handle code and documentation in the object-oriented paradigm as well.

Depending on the incompleteness of the documentation D, one can assist the software developer to complete the documentation. Assume that the developer agrees with the list of not-covered functions in the form of an interactive dialog between the program and the developer, where maximum matchings are shown one by one with corresponding lists of uncovered functions until there is agreement. Upon reaching agreement, the uncovered functions code can be given with a suitable prompt to a code commenter agent to generate the missing documentation for those functions. Cases can arise that lack one-to-one correspondence between the original and generated functions. In such cases, one can resort to the equivalence of the two programs rather than the equivalence of pairs of functions. In such a case, fine-grained incompleteness would be difficult to accomplish without refactoring of the code P or P′ or both.

Redundancy metric automation can use word subsequences of the given documentation, satisfactory in principle, but may be computationally expensive. One can improve flexibility by asking the developer to specify the level of redundancy: word, sentence, paragraph, etc., with example steps assuming the sentence level has been specified. In practice, testing for redundancy can be extremely computationally intensive because there are exponentially many word subsequences of a sequence. An algorithm for measuring the redundancy of a documentation can include inputs Code C, and related Documentation D, subroutine EQ and the desired redundancy level: word, sentence, paragraph (referred to as Units). The following provides a linear time solution to determine whether documentation D is redundant or not. Assume S returns true if the two codes are equivalent and false otherwise.
(1) Assume D=<d1, d2, . . . d(i−1), d(i), d(i+1), . . . d(n)> where each d(i) is a specified Unit (word, sentence, or paragraph).
(2) Flag=false.
(3) Iterate over all the units specified, i.e., for i=1 to n
   (a) Delete unit d(i) from D to obtain D(i)′=<d(1), d(2), . . . d(i−1), d(i+1) . . . d(n)>.
   (b) C(i)′=GenCode(Doc D(i)′).
   (c) Flag=EQ(C, C(i)′).
   (d) If (Flag) return {true}, then Documentation D is redundant at the specified unit level.

An example of the Redundancy metric can be expressed herein with Code C including one function as follows:
(1) Documentation D: Program P implements a function to compute factorial(n). When given integer n>0, factorial(n) function is defined as the product n!=n·(n−|)· . . . ·3·2·1 with 0!=1 . . .
(2) Program P.
(3) function f(n: integer)
(4) #Assumes n >=0
(5) If (n==0) then return 1 else return n*f(n−1)
Then, let unit specified be sentence. Because D has two sentences, the first one can be deleted to obtain D₁′. When given integer n>0, factorial(n) function is defined as the product n!=n·(n−1)· . . . ·3·2·1 with 0!=1. Let C′ equal the empty program, then S (C(1)′, C)=false. Then the D(2)′=Program P implements a function to compute factorial(n). In this case, suppose C(2)′ equals code produced by algorithm in “Completeness Algorithm.” Then S(C(2)′, C)=true. So flag=true and the Algorithm returns true with the documentation D regarded as redundant at sentence level. The above algorithm does not provide a linear time solution to finding a non-redundant documentation which is complete for the associated code. This informs that D is redundant. To find this solution, one can implement an automated, exhaustive search procedure that would go through all the subsequences of the given sequence, which are exponentially many. However, for programs that are run many times over a long period of time, this cost would be worthwhile in terms of future maintenance and update costs.

Approximation algorithm to determine Conciseness of documentation D with respect to code C can include input: Code C and related Documentation D, a parameter K, which is the number of summaries to try at each step, subroutine EQ, tool Summ, and the Unit for conciseness, which could be number of words, sentences or paragraphs. One can use a binary search technique for determining conciseness of D. The example below for Redundancy also works with Unit equals Sentence, with the second sentence defining factorial function as being unnecessary.
(1) Let the decomposition of D(i)′=<d(1), d(2), . . . d(i−1), d(i+1) . . . d(n)> where each d(i) from 1 to n is a specified Unit (word, sentence, or paragraph).
(2) Length=n=|D|; L=Length/2
(3) Generate K summaries S(1), S(2), . . . , S(k) of D using Summ(D, L, Unit).
   (a) For each S(i), call C(i)′=GenCode(S(i)).
   (b) Check EQ(C(i)′, C). If any of the EQ calls returns true, then D is not concise enough and can be replaced with the S(i) of Length L that leads to the true output from EQ.
(4) If none of the EQ calls in step (3)(b) return true, L=L+L/2. If Length −L is sufficiently small (parameter to be specified by user) or 0, stop and return D is concise, otherwise repeat step (3) with the new value of L.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

1. A computer implemented method for evaluating software documentation of a source code to generate an alternate code, said method comprising:
receiving the source code;
parsing and interpreting the source code;
producing a text document that describes purpose and functionality based on the source code;
comparing said text document to the source code for completeness; and
creating the alternate code from said functionality of said text document.

2. The method according to claim 1, wherein the source code and the alternate code are written in different computer languages.

3. The method according to claim 1, wherein said comparing operation further includes measuring comment density.

4. The method according to claim 1, further comprising measuring said text document for clarity and consistency.

5. The method according to claim 1, further comprising measuring said text document for readability.

6. The method according to claim 1, further comprising measuring said text document for traceability between a link and a corresponding position in the original code.

7. The method according to claim 1, further comprising measuring said text document for cohesion and structure.

8. The method according to claim 1, further comprising measuring said text document for functional accuracy.

9. The method according to claim 1, further comprising measuring said text document for grammatical quality.

10. The method according to claim 1, further comprising measuring said text document for continued maintainability.

11. The method according to claim 1, wherein said producing operation further includes assessing audience type.

12. The method according to claim 1, wherein said producing operation further includes determining human language format.

13. The method according to claim 1, wherein said producing operation further includes recognizing authorship.

14. The method according to claim 1, wherein said producing operation further includes recognizing creation date.

15. The method according to claim 1, wherein said producing operation further includes recognizing applicable license.
